(19) United States
(12) Patent Application Publication
(10) Pub. No.: US 2017/0185231 A1
(43) Pub. Date: Jun. 29, 2017

(54) SYSTEM AND METHOD OF DETERMINING A TOUCH INPUT FOR SELECTING A FEATURE ON A TOUCH DISPLAY

(71) Applicants: Ronald Paul Russ, Farmington Hills, MI (US); Matthew Mark Mikolajczak, Novi, MI (US); James Joseph Kornacki, Dearborn, MI (US)

(72) Inventors: Ronald Paul Russ, Farmington Hills, MI (US); Matthew Mark Mikolajczak, Novi, MI (US); James Joseph Kornacki, Dearborn, MI (US)

(21) Appl. No.: 14/981,415

(22) Filed: Dec. 28, 2015

(51) Int. Cl. G06F 3/042

(52) U.S. Cl. CPC G06F 3/0421; G06F 2203/04109

(57) ABSTRACT

An aspect of the present disclosure provides a system and method for determining a touch input for selecting a feature on a touch display. The system includes a sensing circuit disposed adjacent to and separate from the touch display by a predetermined distance. The sensing circuit having an emitter sensor and a receiver sensor, where the emitter sensor projects infrared (IR) light to the touch display and the receiver sensor detects a change of intensity of the IR light in response to a user presses on the touch display such that a threshold force is met when the predetermined distance between the touch display and the sensing circuit narrows by a predetermined amount.

### BACKGROUND

Touchscreen displays are common among a variety of handheld electronic devices as well as in vehicle dashboard. These displays typically may have a resistive screen consisting of a flexible plastic layer and a glass layer, coated with resistive material and separated by an air gap that creates electrical resistance between the layers. When a user touches the screen, the layers touch and define a point of contact which results in a measurement related to the touch position to select a feature of that device. The display may alternatively have a capacitive screen consisting of two spaced layers of glass, coated with conductive material and which allows the user to be the conductive force on the screen. When the user touches the screen, the electrostatic field around the screen changes and is used to pin point the user's selection on the screen to select a feature of that device.

However, both types of touch screen displays are very sensitive and can result in inaccurate or false feature selection. For instance, when a user accidentally or inadvertently touches the display. Alternatively, when the user searches for a desired feature with their finger near, but not touching the screen and still selects an undesired feature as a result of the conductive energy emanating from their finger. For example, a user may desire to select an air-conditioning icon on a vehicle display, but inadvertently selects another icon near the air-conditioning icon as the user searches for the air-conditioning icon.

These displays are very sensitive to temperature, electronic noise, and permanent material deformation issues. As such, resistive or capacitive displays tend to require costly support electronics to remedy these issues.

### SUMMARY

A system and a method of determining a touch input for selecting a desired feature on a touch display is provided.

An aspect of the system includes a sensing circuit disposed adjacent to and separate from the touch display by a predetermined distance. The sensing circuit has an emitter sensor and a receiver sensor, where the emitter sensor projects infrared (IR) light to the touch display and the receiver sensor detects a change of intensity of the IR light in response to a user presses the feature on the touch display such that a threshold force is met when the predetermined distance between the touch display and the sensing circuit narrows by a predetermined amount.

Another aspect of a system includes an emitter configured to project infrared (IR) light to the touch display and a receiver optically coupled to the emitter. The system also includes an electronic control unit in communication with the emitter the receiver. The emitter and receiver are disposed adjacent to and separate from the touch display by a predetermined distance. Further, the receiver detects a change in light intensity in response to a user pressing the feature on the touch display such that a threshold force is met when the predetermined distance between the emitter coupled to the receiver and the touch display is narrowed by a predetermined amount. The receiver further transmits an output signal indicative of the change in light intensity to the electronic control unit.

An aspect of a method of determining a touch input for selecting a feature on a touch display system, where the method utilizes a system with a sensing circuit with an emitter sensor optically coupled to a receiver sensor and the sensing circuit is disposed adjacent to and separate from the touch display by a predetermined distance. The sensing circuit is further communicatively connected to an electronic control unit. The method includes the steps of radiating infrared (IR) light to a back surface of the touch display via the emitter sensor, and detecting a change in IR light intensity reflecting off of the back surface of the touch display via the receiver sensor in response to a user pressing the desired feature of the touch display such that a threshold force is met when the predetermined distance between the sensing circuit and the touch display narrows by a predetermined amount and the IR light intensity increases.

### BRIEF DESCRIPTION OF THE FIGURES

Other aspects of the present disclosure will be readily appreciated, as the same becomes better understood by reference to the following detailed description when considered in connection with the accompanying drawings where:

FIG. 1 is a block diagram of a system of determining a touch input for selecting a feature on a touch display in accordance with an aspect of the present disclosure;

FIG. 2 is a cross-sectional view a system of determining a touch input for selecting a feature on a touch display in accordance with an aspect of the present disclosure;

FIG. 3 is a cross-sectional view of a system of determining a touch input for selecting a feature on a touch display when the user touches a feature on the touch display in accordance with an aspect of the present disclosure;

FIG. 4 is a flowchart of a method for assembling a system of determining a touch input for selecting a feature on a touch display in accordance with an aspect of the present disclosure; and

FIG. 5 is a flowchart of a method for determining a touch input for selecting a feature on a touch display in accordance with an aspect of the present disclosure.

### DETAILED DESCRIPTION OF THE PRESENT DISCLOSURE

Detailed examples of the present disclosure are disclosed herein; however, it is to be understood that the disclosed examples are merely exemplary and may be embodied in various and alternative forms. It is not intended that these examples illustrate and describe all possible forms of the disclosure. Rather, the words used in the specification are words of description rather than limitation, and it is understood that various changes may be made without departing from the spirit and scope of the disclosure. As those of ordinary skill in the art will understand, various features of the present disclosure are illustrated and described with reference to the Figures and may be combined with features illustrated in one or more other Figures to produce examples of the present disclosure that are not explicitly illustrated or described. The combinations of features illustrated provide representative examples for typical applications. However, various combinations and modifications of the features consistent with the teachings of the present disclosure may be desired for particular applications or implementations.

As describe above, touch screen displays are very sensitive and can result in inaccurate or false feature selection when a user accidentally or inadvertently touches the display. Additionally, these displays are very sensitive to temperature, electronic noise, and permanent material deformation issues. As such, resistive or capacitive displays tend to require costly support electronics to remedy these issues. To address these problems, the displays have employed strain gauges to assist in determining the exerted forced required to select a feature on the display. However, the strain gauges experience repeated mechanical assembly issues and wear.

Thus, there is a need for a system and method of determining a touch input for selecting a desired feature on a touch display that recognized when the user desires to select and icon, prevents the user from accidentally or inadvertently selecting icons on the display, and determines the applied force to the screen when a touch input is positive.

The aspects of the present disclosure provides for systems and methods for an improved technique for determining a touch input. In particular, the aspects disclosed herein discuss providing a secondary sensor system, employing lights and light sensors, to determine if a touch is accurate, or if it is a false positive. The aspects disclosed herein employ strategically placed lights (e.g. infrared (IR) lights), and sensors, to determine whether a user is touch is an intended touch. The aspects disclosed herein may employ modifications to control logic that facilitate the secondary sensing, an employing of an algorithm to determine whether the sensed information corresponds to an intended touch, and modifications to existing touch screen implementations to implement the embed light system/sensors disclosed herein.

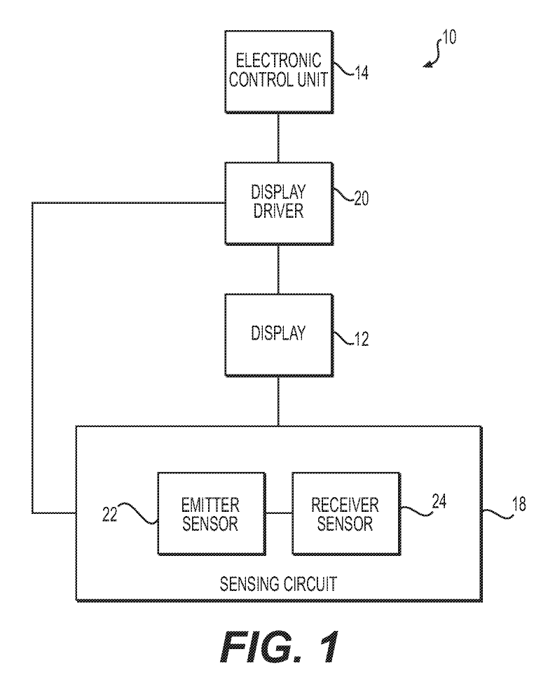

FIG. 1 is a block diagram of a system 10 for determining a touch input for selecting a feature on a touch display 12 in accordance with an aspect of the present disclosure. The system 10 includes an electronic control unit 14 and a display 12. The electronic control unit 14 has a controller (not shown) with hardware and/or software control logic for operating various components, such as the display, within the vehicle and any combination of memory storage such as random-access memory (RAM) and/or read-only memory. The electronic control unit 14 is connected to the display 12 through a display driver 20. The display driver 20 provides power and drives the functions of the display 12 based on the logic from the electronic control unit 14. The display driver 20 may have a wired or wireless connection with both the display 12 and a sensing circuit 18. In one example, the display 12 may be disposed in a vehicle dashboard (not shown). However, it is understood that the display 12 and apparatus 10 disclosed herein may be used in other electronic devices and applications. The front surface of the display 12 may be a capacitive touch screen. The back surface of the display 12 may have reflective material disposed thereon, such as white paper or reflecting tape.

The sensing circuit 18 interacts with the display 12. The sensing circuit 18 is disposed adjacent to and is disposed a predetermined distance away from the display 12, such that a gap is formed between the display 12 and the sensing circuit 18. The predetermined distance may be between 0.5 mm and 5 mm. The sensing circuit 18 includes an emitter sensor 22 that has an infrared (IR) light emitting diode (LED) for emitting or radiating IR light to the back surface of the display 12. The sensing circuit 18 also has a receiver sensor 24 for detecting the intensity of the IR light reflecting off of the back surface of the display 12. The emitter sensor 22 is optically coupled to the receiver sensor 24. The top of each of the IR LED and the receiver 24 are perpendicular to the display 12. As a result, IR light from the IR LED is projected and perpendicularly or diagonally bisects the back surface of the display 12.

In operation, the electronic control unit 14 is configured to determine whether a touch input has occurred. Specifically, the electronic control unit 14 is programmed with control logic for determining a touch input is positive or has occurred when a threshold force is met and indicates that user's intent to select the feature. To determine this, the electronic control unit 14 controls and operates the sensing circuit 18 and in particular, the emitter sensor 22 by reflecting light to the back surface of the display 12. The IR light reflects off of the back surface of the display 12 and the intensity of the IR light is detected by the receiver sensor 24. The receiver sensor 24 transmits an output signal indicative of the intensity of the IR light to the electronic control unit 14, which is processed and corresponds to an applied force.

When a user presses the touch display 12, the touch display 12 compresses and the intensity of the light reflecting off of the display 12 changes. To meet the threshold force, the touch display compresses a predetermined amount. As a result, there is a change or increase in the intensity of the IR light reflecting off of the display 12. The receiver sensor 24 detects the change or increase of the intensity of the IR light and transmits an output signal indicative of the change or increase of the intensity of the IR light reflecting off of the display 12. The electronic control unit 14 determines if the threshold force is met based on the change or increase in the intensity of the light. The threshold force may correspond to the amount of force applied to the display 16. As such, there may be a plurality of threshold forces that correspond to different amounts of applied forces and that may be met or detected by the electronic control unit 14. The threshold force may also be based on the point of contact or position on the display 16.

Additionally, the electronic control unit 14 is programmed with control logic to determine the applied force placed on the touch display 12 when a user presses the display 12 and when the touch input meets the threshold force. The applied force corresponds to a point of contact on the display 12 and the intensity of the IR light reflecting off of the display 12. The point of contact is determined from the X and Y coordinates of the user's press on the touch display 12. In a preferred aspect, the display 12 is a capacitive touch screen. A signal indicating the X and Y coordinates is transmitted to the electronic control unit 14, which references a look up table to determine a requisite force required for that portion of the touch display 12. The requisite force is calibrated to match or equal the threshold force to indicate that a touch or press has occurred.

In another aspect of the present disclosure, the system 10 may use a plurality of sensing circuits 18 to determine the touch input and applied force on the display for a large display and where the sensing circuits 18 each correspond to a region of the larger display.

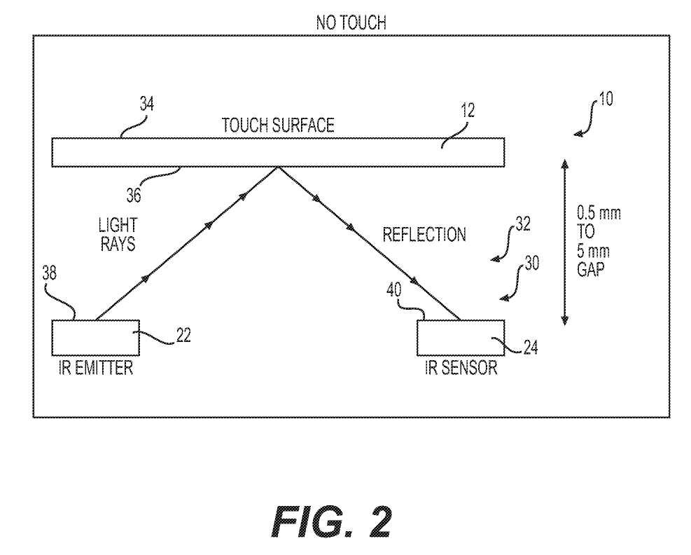

FIG. 2 is a cross-sectional view of a system 10 of determining a touch input for selecting a feature on a touch display 12 in accordance with an aspect of the present disclosure. Similar to FIG. 1, FIG. 2 shows a touch display 12 that is adjacent to and is separate from an emitter 22 and a receiver 24 by a predetermined distance 30 forming a gap 32. The predetermined distance 30 between the display 12, and the emitter 22 and receiver 24 is 0.5 mm to 5 mm when the user is not pressing the touch screen display 12. The display 12 has a front surface 34 that faces the user and a back surface 36. The front surface 34 is a capacitive touch screen. The back surface 36 faces the emitter 22 and the receiver 24. The back surface 36 may have a reflective material disposed thereon, such as a white paper or a reflective tape, to change the reflected light intensity from the emitter 22. As a result, the output signal indicating change of intensity is lower or raised based on the reflective material. However, it is important to note, that the reflective material is optional addition on the back surface 36 of the display 12 to change the intensity of the reflection of the IR light and is not required for the receiver 24 to detect the IR light. The emitter 22 is an IR emitter that projects or radiates IR light perpendicularly or diagonally to the display 12 and the receiver 24 is an IR sensor that detects IR light reflecting perpendicularly or diagonally from the display 12. The top 38 or output of the IR emitter 22 and the top 40 or input of the IR sensor 24 are each perpendicular to the display 12. The electronic control unit (not shown) is configured to continuously sample the output of the receiver 24 to determine if a change in light intensity or a change in the magnitude of the output signal has occurred. When a change in light intensity occurs and the threshold force is met, then a feature selected by the user will be activated and a press is deemed to have occurred. When the user does not press the front surface 34 of the touch display 12 or when the threshold force is not met, the display 12 remains in the predetermined distance 30 from the emitter 22 and receiver 24 such that the intensity of the IR light on the back surface 36 of the display 12 remains unchanged. By sampling the output of the receiver 24, sensor fluctuation due to environmental changes such as temperature, humidity, wear and tear, and the like are eliminated and robust performance is obtained.

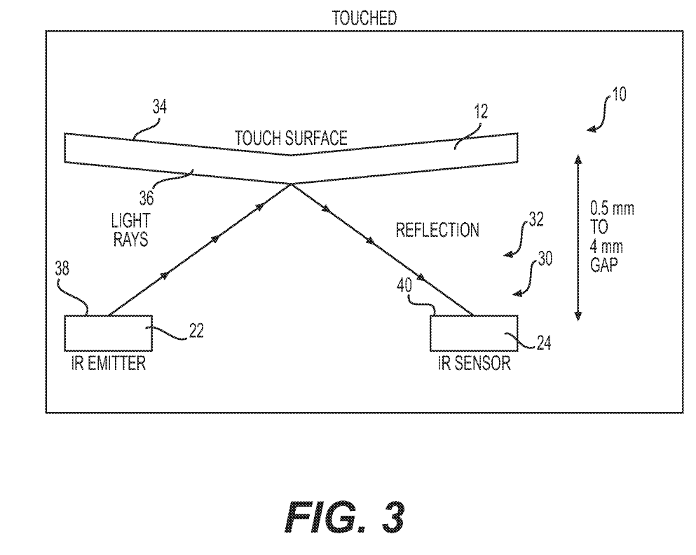

FIG. 3 has the same configuration as FIG. 2, except that the user has pressed the touch display 12. When the user presses the display 12, the predetermined distance 30 between the display 12 and the emitter/receiver 22, 24 decreases or narrows. If the predetermined distance 30 narrows predetermined amount, the intensity of the light reflecting off of the back surface 36 of the display 12 increases or changes and is detected by the receiver 24. The predetermined amount is between 0.5 mm and 4.0 mm. The receiver 24 outputs a signal indicative of the increase or change in intensity to the electronic control unit (not shown) which then determines if the threshold force is met. When the threshold force is met, the selected feature on the touch screen display 12 is activated.

The change in light intensity and the change in the predetermined distance 30 between the display 12 and the emitter/receiver 22, 24 corresponds to the point of contact on the touch display 12, which may be referenced through a look-up table stored on the electronic control unit 14. Additionally, the actual applied force may be determined based on and is a function of the point of contact and the change in light intensity.

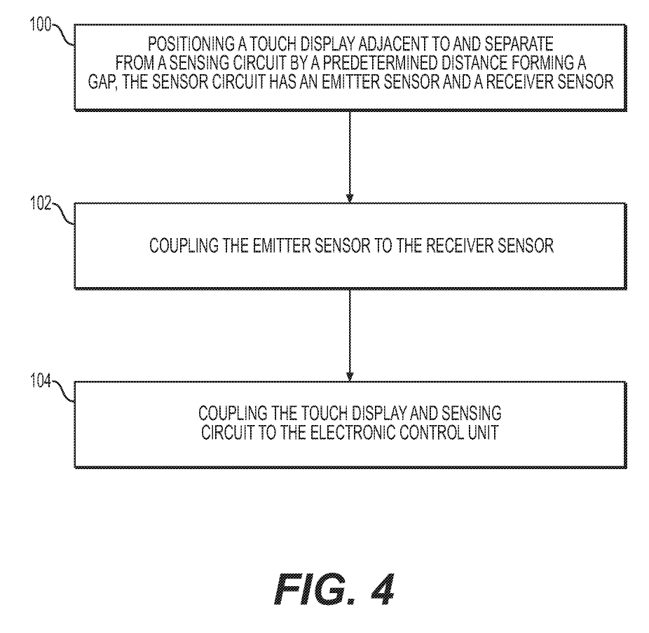

FIG. 4 is a flowchart of a method for assembling a system of determining a touch input for selecting a feature on a touch display in accordance with an aspect of the present disclosure, as described in FIGS. 1-3. The method includes positioning the touch display adjacent to and separate from a sensing circuit by a predetermined distance forming a gap therebetween 100. The sensing circuit includes an emitter sensor and a receiver sensor. The method also includes optically coupling the emitter sensor to the receiver sensor 102. The emitter sensor is configured to radiate IR light to the back surface of the display. The receiver sensor is configured to detect a change in light intensity reflecting off the back surface of the display. The touch display and sensing circuit is further coupled to the electronic control unit 104.

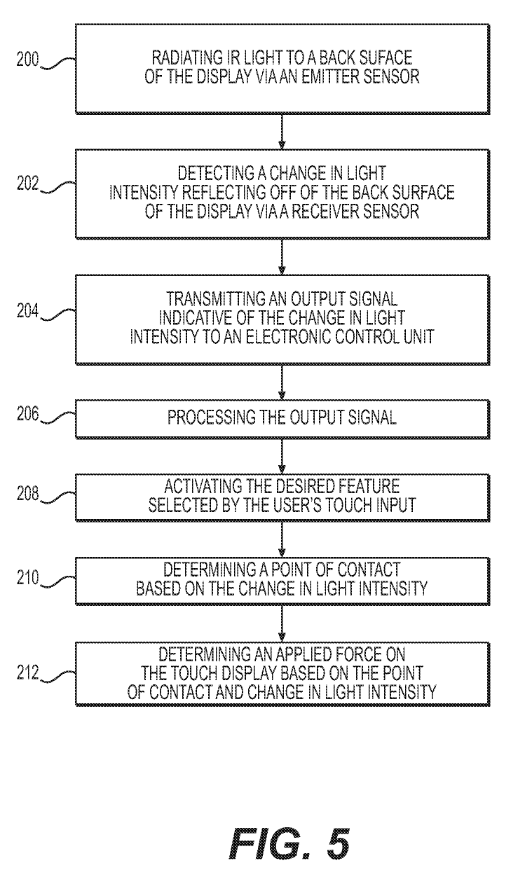

FIG. 5 is a flowchart of a method of determining a touch input for selecting a feature on a touch display in accordance with an aspect of the present disclosure. The method of FIG. 5 uses the system described in FIGS. 1-4. The method includes radiating IR light to a back surface of the display via an emitter sensor 100 and detecting a change of light intensity of IR light reflecting off of the back surface of the display via a receiver sensor 102. Specifically, the receiver sensor detects the change of intensity in response to a user engaging or pressing the display such that the predetermined distance between the display and the emitter sensor/receiver sensor is narrowed by a predetermined amount.

Once the change of intensity is detected 102, an output signal indicative of the change in light intensity is transmitted to the electronic control unit 104. The electronic control unit processes the output signal 106 and the electronic control unit activates the feature selected by the user's touch input 108.

Additionally, after the output signal is processed 106, the electronic control unit can determine a point of contact on the touch screen display based the X and Y coordinates of the touch display where the press occurred 110. Once the point of contact is determined, the actual applied force of the user's touch input is determined via a look-up table stored on the electronic control unit 112. The actual applied force is proportional and corresponds to the point of contact on the display and the change of light intensity detected by the receiver.

While examples of the disclosure have been illustrated and described, it is not intended that these examples illustrate and describe all possible forms of the disclosure. Rather, the words used in the specification are words of description rather than limitation, and it is understood that various changes may be made without departing from the spirit and scope of the disclosure. Additionally, the features and various implementing aspects may be combined to form further examples of the disclosure.

We claim:

1. A system for determining a touch input for selecting a feature on a touch display, comprising:
a sensing circuit disposed adjacent to and separate from the touch display by a predetermined distance, the sensing circuit having an emitter sensor and a receiver sensor;
wherein the emitter sensor projects infrared (IR) light to the touch display and the receiver sensor detects a change of intensity of the IR light in response to a user pressing the desired feature on the touch display such that a threshold force is met when the predetermined distance between the touch display and the sensing circuit narrows by a predetermined amount.

2. The system of claim 1, wherein an electronic control unit is communicatively connected to the sensing circuit and wherein the electronic control unit is configured to select the feature when the threshold force is met.

3. The system of claim 1, wherein the predetermined distance is set based on a sensor.

4. The system of claim 1, wherein the predetermined distance is set based on the IR light.

5. The system of claim 1, wherein the touch display is covered with a reflective material to increase the intensity of the IR light reflecting off of the display.

6. The system of claim 1, wherein the emitter sensor is a discrete light emitting diode (LED).

7. The system of claim 1, wherein the receiver sensor is an IR sensor.

8. The system of claim 1, wherein the sensing circuit is a plurality of sensing circuits.

9. A system for determining a touch input for selecting a desired feature on a touch display, comprising:
an emitter configured to project infrared (IR) light to the touch display;
a receiver optically coupled to the emitter;
an electronic control unit in communication with the emitter and the receiver,
wherein the emitter and the receiver are disposed adjacent to and separate from the touch display by a predetermined distance,
wherein the receiver detects a change in light intensity in response to a user pressing the desired feature on the touch display such that a threshold force is met when the predetermined distance between the emitter coupled to the receiver and the touch display is narrowed by a predetermined amount, and
wherein the receiver transmits an output signal indicative of the change in light intensity to the electronic control unit.

10. The system of claim 9, wherein the receiver transmits an output signal indicating the change in intensity of the IR light to the electronic control unit.

11. The system of claim 9, wherein the electronic control unit is configured to compare the user's point of contact on the display detected via a touch sensor with the change of light intensity via the receiver.

12. The system of claim 10, wherein the electronic control unit is configured to determine the applied force of the user's press on the touch display based on the point of contact on the display and the change of light intensity.

13. The system of claim 9, wherein the electronic control unit and the touch display are connected through a display driver.

14. The system of claim 9, wherein the predetermined distance is based on a sensor.

15. The system of claim 9, wherein the predetermined is set based on the IR light.

16. A method of determining a touch input on a touch display, comprising:
radiating infrared (IR) light to a back surface of the touch display; and
detecting a change in IR light intensity reflecting off of the back surface of the touch display via an IR sensor, in response to a user pressing the touch display.

17. The method of claim 16, further comprising:
transmitting an output signal indicative of the change in IR light intensity to the electronic control unit.

18. The method of claim 16, further comprising:
activating a feature once a threshold force has been met.

19. The method of claim 17, further comprising:
determining a point of contact on the touch display based on the change in IR light intensity via the electronic control unit.

20. The method of claim 19, further comprising:
determining an actual applied force on the touch display via a look-up table stored on the electronic control unit, wherein the actual applied force corresponds to the point of contact on the display and the change of IR light intensity detected by the receiver.
